(19) United States
(12) Patent Application Publication
(10) Pub. No.: US 2024/0003190 A1
(43) Pub. Date: Jan. 4, 2024

(54) LADDER ARRANGEMENT

(71) Applicant: TACTICAL DESIGN AND TESTING SERVICES OY, Rovaniemi (FI)

(72) Inventor: Andreas NYMAN, Espoo (FI)

(21) Appl. No.: 18/251,933

(22) PCT Filed: Nov. 4, 2021
(86) PCT No.: PCT/FI2021/050747

§ 371 Date: May 5, 2023

(30) Foreign Application Priority Data
Nov. 5, 2020 (FI) 20206111

(51) Int. Cl. E06C 7/48; E06C 7/18

(52) U.S. Cl. CPC E06C 7/482; E06C 7/183

(57) ABSTRACT

Disclosed is a ladder arrangement secured to a container. Climbing on the roof or to the top of a container may be unsafe for the user if the upper end of the ladder cannot be firmly secured. The present ladder arrangement includes a fasten provided in the ladder, which can be arranged from the lower level of the container into the fastening position in the container corner piece and into the release position for detaching the ladder from the container corner piece.

### PRIOR ART

The invention relates to a ladder arrangement, especially a ladder arrangement secured to a container.

### BACKGROUND OF THE INVENTION

In freight traffic at sea, on land as well as on rail, cargo is mainly carried in freight containers of standard size and shape. When handling containers, it is sometimes necessary to climb on the roof of a container or, for example, to detach e.g. lifting chains from the corners of a container. However, a ladder placed against a container without securing it may be unsafe for the user and lead to dangerous situations or even injuries.

### SUMMARY OF THE INVENTION

The aim of the present invention is to provide a solution, wherein the abovementioned disadvantages are eliminated or alleviated. The invention particularly aims to solve the problem of how to secure a ladder safely and easily in connection with a container.

The aims of the invention are achieved by means of the characteristics specified in independent claim 1. The ladder arrangement according to the invention is characterised by what is disclosed in the characterising part of claim 1.

A ladder arrangement according to one embodiment of the present invention comprises a ladder placed against a top corner of a container and fastening means provided in connection with the ladder, which means can be arranged from the lower level of the container into the fastening position in the container corner piece and into the release position for detaching the ladder from the container corner piece.

According to one embodiment, the fastening means are provided in connection with a handrail.

According to yet another embodiment, the handedness of the fastening means can be changed.

Preferred embodiments of the invention are also disclosed in the dependent claims.

The invention provides significant benefits. The invention allows a ladder to be secured to a container in such a way that the ladder is safe to use. In addition, the ladder can be quickly secured and detached from the ground without separate tools. The fastening means connected to the handrail may also increase user safety when ascending or descending the ladder. Furthermore, changing the handedness makes it possible to secure the ladder to either the right or left corner piece of the container according to the user's needs.

In this application, the term “number” refers to any positive integer starting from number one (1), for example one, two or three, etc.

### BRIEF DESCRIPTION OF THE FIGURES

Preferred embodiments of the invention are described in greater detail in the following, with reference to the accompanying drawings, in which

FIG. 1 shows a sideview of a ladder arrangement according to an embodiment of the invention when secured to a container, and

FIG. 2 shows a closer view of the area marked A in FIG. 1.

### DETAILED DESCRIPTION OF THE EMBODIMENTS

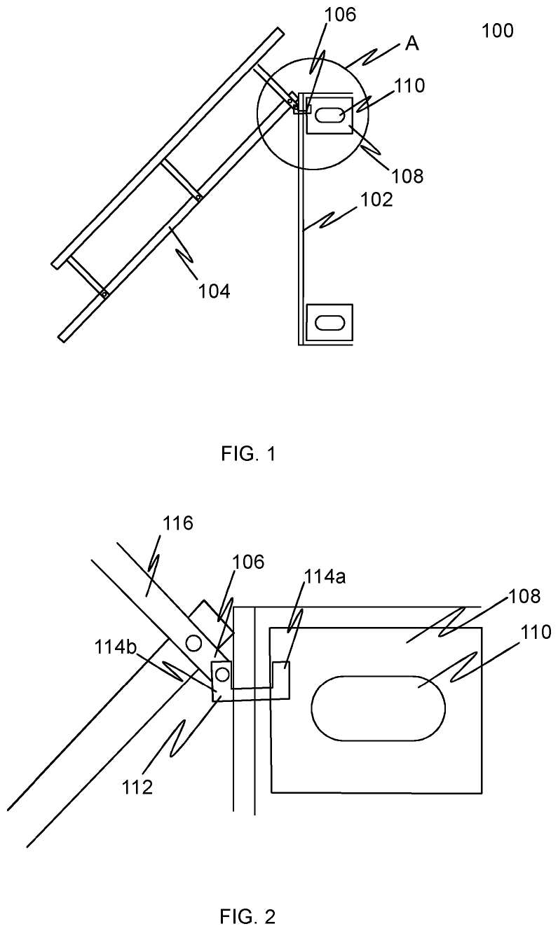

FIG. 1 shows a sideview of a ladder arrangement according to an embodiment of the invention when secured to a container. The ladder arrangement 100 according to an embodiment of the present invention comprises a ladder 104 placed against a top corner of a container 102 and fastening means 106 provided in connection with the ladder. In the embodiment shown in FIG. 1, the fastening means 106 are arranged in the fastening position.

In a standard container, in each corner is provided a container corner piece 108 which comprises an aperture 110 provided on each side of the container, for example for lifting and/or securing the container. In the present invention, the fastening means are arranged in an aperture 110 of a container corner piece in the top corner of the container.

FIG. 2 shows a closer view of the area marked A in FIG. 1. The fastening means 106 are arranged in connection with the ladder 104 in such a way that in the fastening position, the fastening member 112 of the fastening means is positioned in the container corner aperture 110. In the case of FIG. 2, the aperture in which the fastening member 112 is arranged is out of sight on the other side of the container, but the other aperture of the container corner piece is shown in the Figure to clarify the invention.

According to one embodiment, the fastening member 112 comprises two edges 114a and 114b, which are in the fastening position positioned inside and outside the aperture 110 of the container corner piece, thus securing the ladder to the container corner piece 108.

According to one embodiment, the fastening member 112 is immovably fastened to a fastening aim 116 arranged at the upper end of the ladder. According to another embodiment, the fastening member 112 and the fastening arm 116 are formed of one piece.

The fastening arm 116 is arranged rotatably in connection with either side of the ladder in such a way that the position of the fastening arm with respect to the ladder can be arranged into a first position or a second position by rotating the fastening arm. The second position of the fastening arm 116 is essentially perpendicular to the ladder in the fastening position, whereupon the fastening member 112 is locked in the aperture 110 of the container corner piece, and the first position in the release position, whereupon the fastening arm 116 is rotated from the perpendicular position towards the upper end of the ladder, thus releasing the fastening member 112 from the aperture 110.

The fastening arm 116 is provided with means for rotating it into the desired position from the lower level of the container. According to one embodiment, the fastening arm 116 is arranged in connection with the handrail, whereupon in the release position, the handrail is positioned essentially on the level of the ladder and parallel to the ladder. In the fastening position, the fastening arm 116 lifts the handrail to a level suitable for the user. The handrail is preferably arranged to be sufficiently long for the user to be able to secure the ladder by pulling the handrail downwards, whereupon the fastening arm ascends essentially perpendicularly with the ladder. Release takes place by pushing the handrail forward.

A person skilled in the art knows that the handrail does not have to reach down to the lower end of the ladder, but the handrail can be arranged to end 1 m-1.5 m before the lower end of the ladder. A person skilled in the art further knows that the ladder arrangement comprises at least one other arm arranged to the ladder in order for the hand rail to rise over its entire length to the desired level.

According to another embodiment, the fastening arm is connected to another means, such as a cable or a lever mechanism, which is arranged to be used from the lower end of the ladder as disclosed above.

According to yet another embodiment, the handedness of the fastening means can be changed. This can be implemented by providing identical apertures on each side of the ladder for fastening the fastening means to the side of the ladder.

1. A ladder arrangement comprising a ladder placed against a top corner of a container and fastening means provided in connection with the ladder, which means can be arranged from the lower level of the container into the fastening position in the container corner piece and into the release position for detaching the ladder from the container corner piece.

2. The ladder arrangement as claimed in claim 1, wherein the said fastening means are arranged in connection with a handrail.

3. The ladder arrangement as claimed in claim 1, wherein the handedness of the said fastening means can be changed.

4. The ladder arrangement as claimed in claim 2, wherein the handedness of the said fastening means can be changed.
